(19) United States
(12) Patent Application Publication
(10) Pub. No.: US 2014/0312672 A1
(43) Pub. Date: Oct. 23, 2014

(54) Adjustable Head Rest

(71) Applicant: Nathan A. Scolari, Greenville, SC (US)

(72) Inventor: Nathan A. Scolari, Greenville, SC (US)

(21) Appl. No.: 14/203,795

(22) Filed: Mar. 11, 2014

Related U.S. Application Data
(60) Provisional application No. 61/790,841, filed on Mar. 15, 2013.

(51) Int. Cl. B60N 2/48

(52) U.S. Cl. CPC B60N 2/4882; B60N 2/4805
USPC 297/391

(57) ABSTRACT

This invention is directed to a head rest for a vehicle comprising: a concave cradling area to receive a user's head; a plurality of cushioning areas included in the cradling area to provide cushioning for the user's head; a pair of support arms pivotally connected at the cradling area on the left and right side of the cradling area so that a portion of the support arms can protrude away from the cradling area; arm posts attached to each support arm extending rearward and received into the cradling area allowing the lower end of the support arm to slide in to and away from the cradling area to support the sides of the user's head when the support arms are extended away from the user's cradling area.

### BACKGROUND OF THE INVENTION

1) Field of the Invention

This invention is directed to a head rest that can be adjusted to support the user's head.

2) Description of Related Art

Head rests are generally known in the art. However, most head rests do very little to support the head and prevent it from moving in a side to side, lateral movement. Particularly, when a traveler is in an automobile or airplane, it may be desirable for the travelers to sleep while traveling. The challenges are that the normal sleeping position is horizontal and not vertical or in the seated position. When in the seated position, the traveler's head will fall and can awake the traveler abruptly. Further, if the head is not in a vertical position, muscle cramps and soreness can occur from an improper sleeping position.

There have been many efforts to provide for a travel pillow to support the head laterally when the traveler attempts to sleep while traveling. However, each of these attempts require the traveler to purchase and carry their own pillow. Such attempts include United States Patent Application Publication 2013/0232693, U.S. Pat. No. 8,584,285 and United States Patent Application Publication 2013/0254998.

An attempt to secure a traveler's head in an upright position is shown in U.S. Pat. No. 8,469,452 which is an attachment to a seat. However, this also requires that the device be purchased and carried by the traveler. Further, this particular device includes the risk of choking the traveler resulting in very serious injury.

Another attempt to provide for an upright sleeping traveler is U.S. Pat. No. 2,306,334, however, this device only supports the traveler on one side. U.S. Pat. No. 2,464,435 discloses panel that can be placed beside the user's head, but is limited in the support it provides due to the limited movement of the side panels. The same disadvantage is present in U.S. Pat. Nos. 7,364,239; 7,213,884 and 7,093,903.

Accordingly, it is an object of this invention to provide a head rest with moveable arms that may be adjusted to better support the head and prevent lateral movement of the user's head.

### SUMMARY OF THE INVENTION

This invention is directed to a head rest for a vehicle comprising: a concave cradling area to receive a user's head; a plurality of cushioning areas included in the cradling area to provide cushioning for the user's head; a pair of support arms pivotally connected at the cradling area on the left and right side of the cradling area so that a portion of the support arms can protrude away from the cradling area; arm posts attached to each support arm extending rearward and received into the cradling area allowing the lower end of the support arm to slide in to and away from the cradling area to support the sides of the user's head when the support arms are extended away from the user's cradling area.

The head rest can also include a plurality of cushioning areas that have differing levels of firmness and a release mechanism can be carried by the cradling area and engaging the support arm post to secure the support arm post from movement so that the user can position and secure the support arms in a selected position.

The arm posts can be friction fit with the cradling area so that the user can position and secure the support arms in a selected position. The head rest can include a first position where the support arms are generally vertical in relation to the cradling area and a second position where the support arms are generally horizontal in relation to the cradling area, therein the second position provides lateral support for the user's head and the support arms can rotate between the first and the second position. The arms can rotate in excess of 90°. A pivot point can be included where a support arm is connected to the cradling area disposed generally at the top, middle or bottom of the cradling area. The support arms can telescope laterally away from the cradling area.

A pocket can be attached to one support arm. A speaker can be included in a support arm to allow for audio to be presented to the user through a speaker that can be positioned generally at the user's ear. The pivot point, attaching a support arm to the cradling area, can allow the support arm to telescope laterally away from the cradling area. The support arm can be angled forward in relation to the cradling area and rotate about the pivot point to provide for desirable placement of the support arm by the user.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIGS. 1A through 1C show perspective views of the invention in accordance with an embodiment of the invention;

FIG. 2 shows perspective view of the invention in accordance with another embodiment of the invention; and,

FIG. 3A shows perspective view of the invention in accordance with another embodiment of the invention;

FIG. 3B shows a side elevation view of the invention in accordance with another embodiment of the invention;

FIG. 3C shows a side elevation view of the invention in accordance with another embodiment of the invention;

FIG. 4A shows perspective view of the invention in accordance with another embodiment of the invention;

FIG. 4B shows a side elevation view of the invention in accordance with another embodiment of the invention;

FIG. 5A shows perspective view of the invention in accordance with another embodiment of the invention;

FIG. 5B shows a side elevation view of the invention in accordance with another embodiment of the invention; and,

FIG. 5C shows a side elevation view of the invention in accordance with another embodiment of the invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

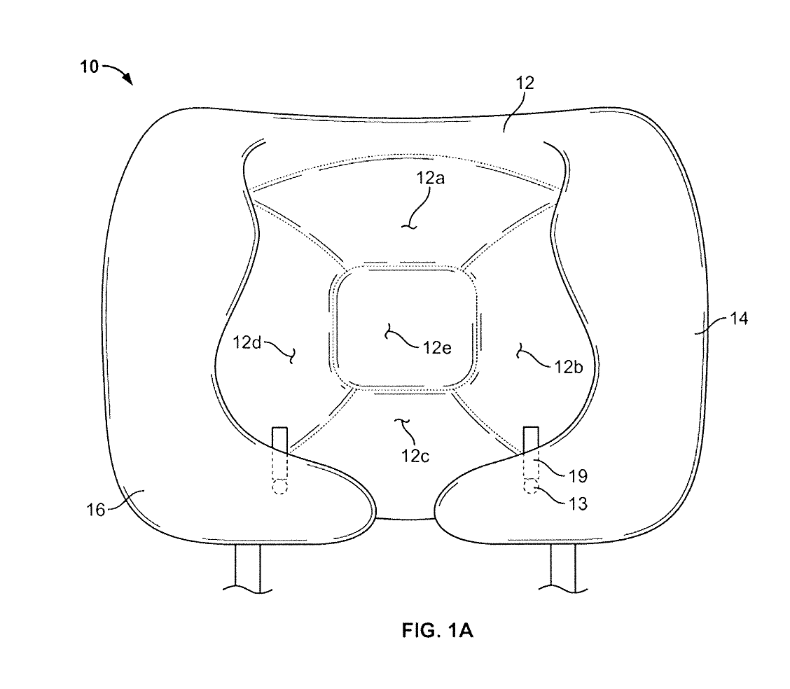

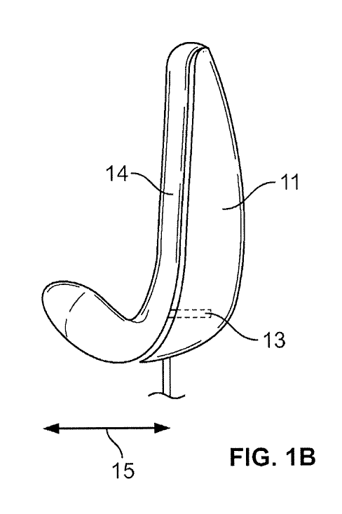

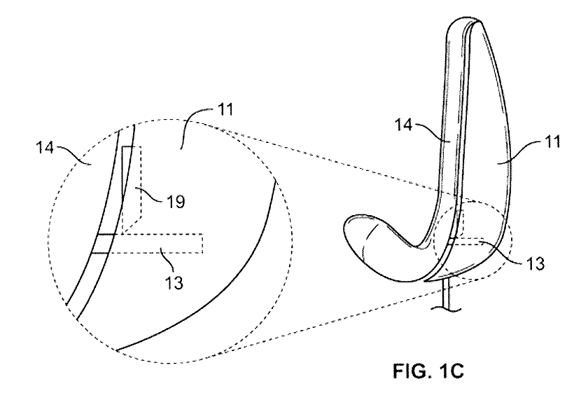

With reference to the drawings, the invention will now be described in more detail. Referring now to FIG. 1A a head rest 10 has a head cradling area 12 that is concave. In one embodiment, the cradling area can include a plurality of cushioning areas 12a through 12e. Each of the cushioning areas can include different levels of firmness to increase the comfort of the user. The head rest further includes two support arms 14 and 16 which are laterally spaced so that they protrude further from the head rest than the head cradling area 12. The cradling area can be recessed so that the user's head can be received into the cradling area. In this arrangement, additional support is provided that can inhibit lateral movement of the user's head. Support arms are slideably attached to the head rest so that they may slide forward and rearward relative to the cradling area. The arms can be connected generally at the top of the center portion of the head rest.

Referring to FIG. 1B, the arm 14 is shown connected to the back 11 by arm post 13 allowing the leg 14 to slide in a direction shown as 15. FIG. 10 shows the leg extended away from the back.

This arrangement allows for the support arms to engage more of the user's head based upon the physical dimensions and posture of the user. In one embodiment, the support arms 14 and 16 may only slide when a release mechanism, such as a clamp or clip 17 is released. When engaged, the release mechanism prevents the support arms from sliding. In one embodiment, a pressure post 19 applies downward pressure on the arm post securing it in a set location. When the pressure post is raised, pressure from the arm post is released allowing the leg to slide. In an alternate embodiment, however, the support arms may freely slide when pulled by the user.

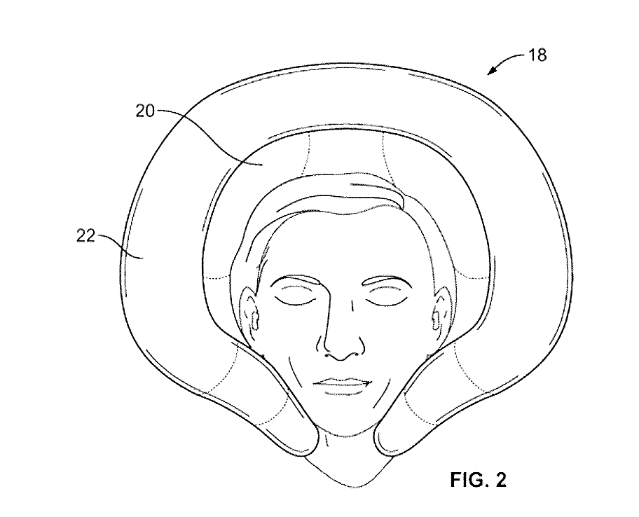

Referring now to FIG. 2, an alternate embodiment of a head rest 18 is shown. This head rest has a head cradling area 20 which is concave. The head rest further includes a support tube 22 disposed around the perimeter of the head rest. This support tube is moldable so that it can be shaped to fit snugly against the user's head. The support tube is moldable into a shape according to the user's physical dimensions so that when the shape is molded into a particular position it retains the position to provide support for the user. The support tube also protrudes further from the head cradling area 20 so as to engage more of the user's head to prevent the side to side motion of the head. The support tube can include support arms attached to the ends of the support tube that can be positioned inward to provide lateral support for the user's head.

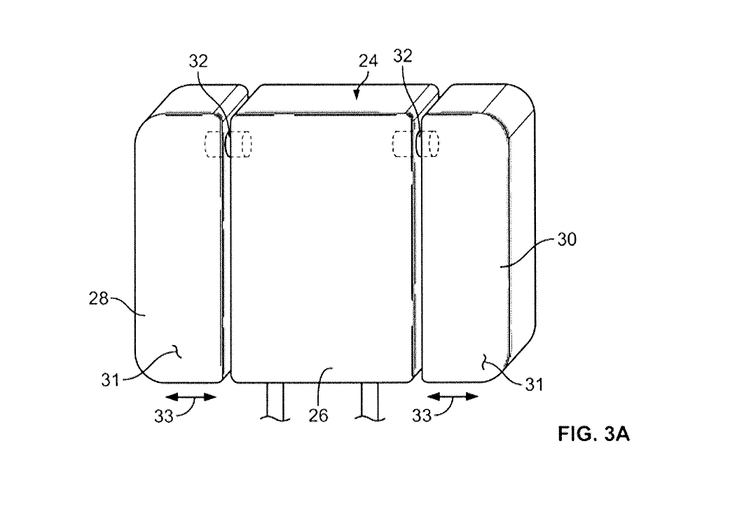

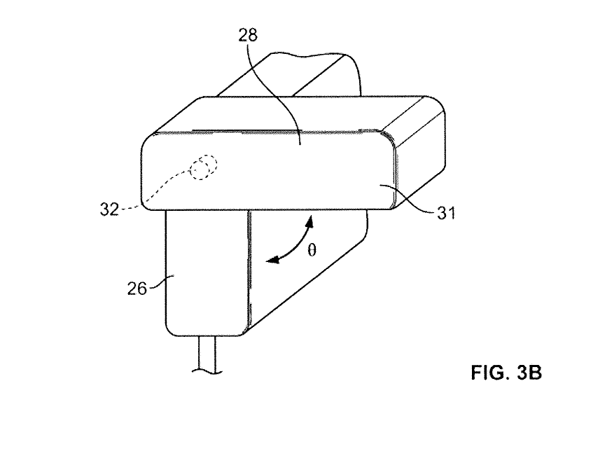

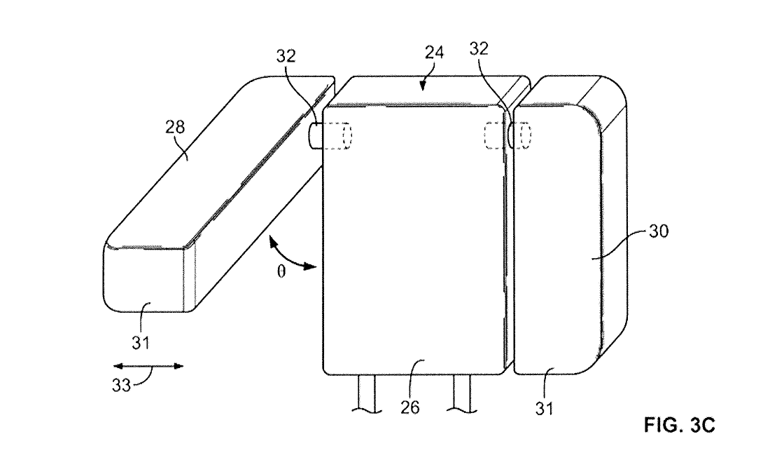

Referring now to FIGS. 3A and 3B, an alternate embodiment of an adjustable head rest 24 is shown. Head rest has a center portion 26 that supports the back of the users head and two support arms 28 and 30 that are pivotally connected to the center portion at 32, generally disposed at the bottom of the center portion. The arms can include a distal end 31 that rotates away from the head rest so that the arms are disposed beside the head of the user. The arms can pivot independently allowing for more flexibility of configurations by the user. In one embodiment, the pivot point allows for the arms to rotate from a vertical to a horizontal position while also allowing the distal end to move laterally in a direction shown as 33.

As can be seen in FIGS. 3B and 3C, support arm 28 can rotate along angle θ so that the support arm supports the side of the user's head to prevent lateral movement of the head. In one embodiment, the range of θ is 90° or less. In one embodiment, the range of θ is greater than 90°.

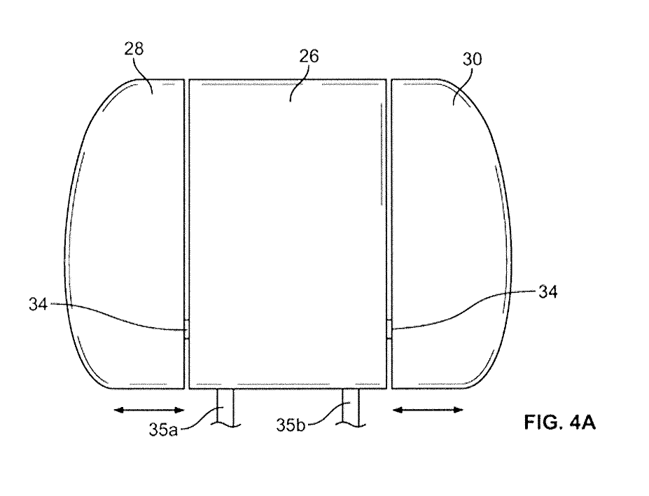

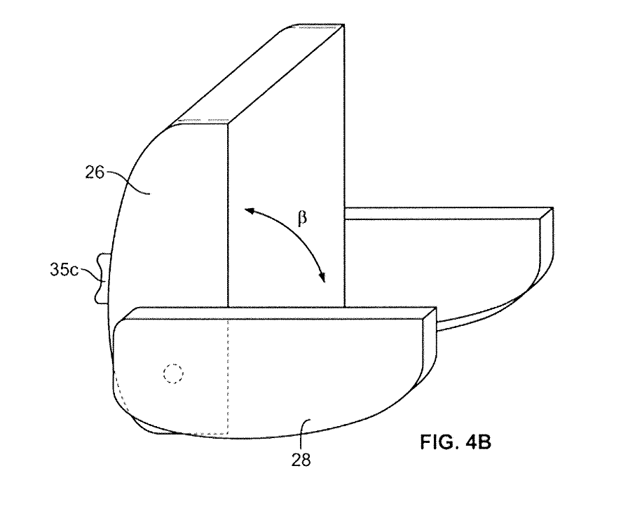

Referring now to FIGS. 4A and 4B, the support arms can be pivotally connected to center portion 26 at the bottom of center portion at pivot 34. In this embodiment, support arm 28 can rotate in direction 13 so that the support arm supports the side of the user's head to prevent lateral movement of the head. The center portion can be attached to the seat through one or more attachment members shown as 35a through 35c.

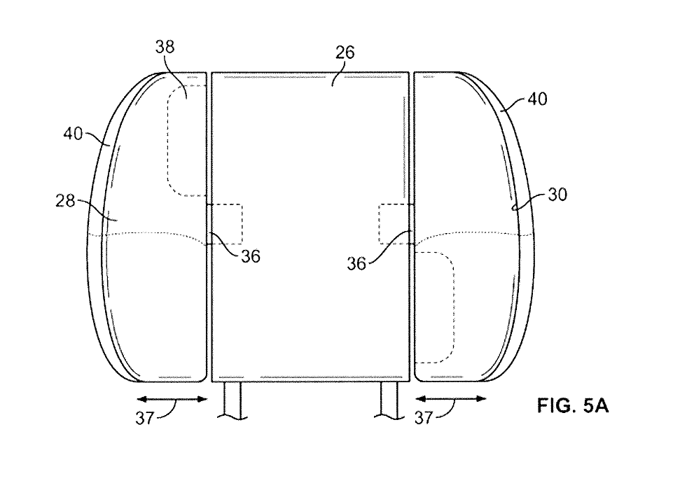

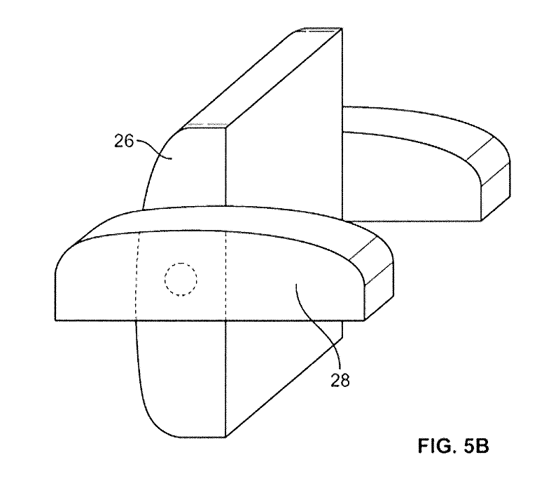

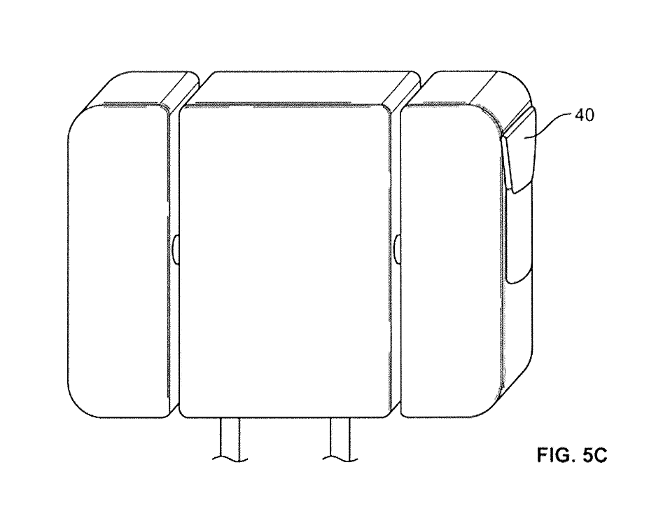

Referring now to FIGS. 5A through 5C, support arms 28 and 30 can be pivotally connected in the middle of center portion 26 at pivot 36. In one embodiment, the support arms can rotate 360° so that the ends of the support arms can be disposed in front of or behind the center portion thereby supporting the user's head to arrest lateral movement of the head. The arms can also telescope toward and away from the center portion along path 37 thereby providing for differing physical dimensions of the user.

In one embodiment, the arms can include audio speakers 38 disposed in the support arms so that when the support arms are rotated out to engage the side of the user's head, the speakers are adjacent to the user's ears. In one embodiment, the support arms may include pockets 40 to store items such as eyeglasses, eye coverings and the like.

While a preferred embodiment of the invention has been described using specific terms, such description is for illustrative purposes only, and it is to be understood that changes and variations may be made without departing from the spirit or scope of the following claims.

What is claimed is:

1. A head rest for a vehicle comprising:
a concave cradling area to receive a user's head;
a plurality of cushioning areas included in the cradling area to provide cushioning for the user's head;
a pair of support arms pivotally connected at the cradling area on the left and right side of the cradling area so that a portion of the support arms can protrude away from the cradling area and are disposed generally orthogonal to the cradling area; and,
arm posts attached to each support arm extending rearward and received into the cradling area allowing the lower end of the support arm to slide in to and away from the cradling area to support the sides of the user's head when the support arms are extended away from the user's cradling area.

2. The head rest of claim 1 including a plurality of cushioning areas that have differing levels of firmness.

3. The head rest of claim 1 including a release mechanism carried by the cradling area and engaging the support arm post to secure the support arm post from movement so that the user can position and secure the support arms in a selected position.

4. The head rest of claim 1 wherein the arm posts are friction fit with the cradling area so that the user can position and secure the support arms in a selected position.

5. The head rest of claim 1 including a first position where the support arms are generally vertical in relation to the cradling area and a second position where the support arms are generally horizontal in relation to the cradling area, therein the second position provides lateral support for the user's head and the support arms can rotate between the first and the second position.

6. The head rest of claim 6 wherein the support arms can rotate in excess of 90°.

7. The head rest of claim 1 including a pivot point where a support arm is connected to the cradling area disposed generally at the top of the cradling area.

8. The head rest of claim 1 including a pivot point where a support arm is connected to the cradling area disposed generally in the middle of the cradling area.

9. The head rest of claim 1 including a pivot point where a support arm is connected to the cradling area disposed generally at the bottom of the cradling area.

10. The head rest of claim 1 wherein the support arms can telescope laterally away from the cradling area.

11. The head rest of claim 1 including a pocket attached to one support arm.

12. The head rest of claim 1 including a speaker included in a support arm to allow for audio to be presented to the user through a speaker that can be positioned generally at the user's ear.

13. The head rest of claim 1 including a pivot point attaching a support arm allowing the support arm to telescope laterally away from the cradling area, be angled forward in relation to the cradling area and rotate about the pivot point to provide for desirable placement of the support arm by the user.

14. A head rest for a vehicle comprising:
a cradling area; and,
a support arm attached to the cradling area at a pivot point so that the support arm may telescope laterally away from the cradling area, be angled forward in relation to the cradling area and rotate about the pivot point to provide for desirable placement of the support arm by the user.

15. The head rest of claim 14 wherein the cradling area is recessed to receive the user's head.

16. The head rest of claim 14 wherein the pivot point allows the support arm to rotate 360°.

17. The head rest of claim 14 wherein the support arm rotates downward to extend over half the support arm forward of the cradling area to provide lateral support for the user's head.

18. The head rest of claim 14 wherein the support arm rotates upwards to extend over half the support arm forward of the cradling area to provide lateral support for the user's head.

19. A head rest for a vehicle comprising:
a concave cradling area for receiving a user's head;
a support tube disposed in a semi-circular manner around the top perimeter of the cradling area;
support arms movably attached to the ends of the support tube that can be positioned inwards to provide lateral support for the user's head.

20. The head rest of claim 19 wherein the support tube is moldable so that it can be positioned to engage more of the user's head.
